(19) United States
(12) Patent Application Publication
(10) Pub. No.: US 2012/0139268 A1
(43) Pub. Date: Jun. 7, 2012

(54) Locking device provided with at least one locking point for a sliding sash

(75) Inventor: Eric Joray, St-Aubin (CH)

(73) Assignee: Orchidees Constructions S.A.

(21) Appl. No.: 13/066,187

(22) Filed: Apr. 8, 2011

(30) Foreign Application Priority Data
Dec. 1, 2010 (EP) 10193330.7

(51) Int. Cl. E05B 65/08; E05C 1/12; E05C 1/10

(52) U.S. Cl. 292/157; 292/138

(57) ABSTRACT

The invention relates to a locking device provided with at least one locking point, in particular for windows, doors, sliding patio doors or the like constructed from an assembly of profiled parts, having at least one locking bar (24a, 24b) sliding inside a sash (2), the said bar being moveable under the action of a sliding unit (18a, 18b) fixedly attached to the said bar between an unlocking position, in which the said bar is disposed outside a frame element adjacent to the said sash (2), and a locking position, in which the said bar is disposed partially inside the said frame element, and at least one actuating element (6, 106) accessible from outside the said sash (2), wherein the said actuating element (6, 106) is configured to act on an associated member (17a, 17b) connected to the sliding unit (18a, 18b) when it is displaced in translation along an axis of displacement from an initial position to a final position so as to cause displacement of the said locking bar (24a, 24b) from its unlocking position to its locking position.

### CROSS-REFERENCE TO RELATED APPLICATIONS

The present application claims priority to European Patent Application 10193330.7, filed Dec. 1, 2010.

### TECHNICAL FIELD

The present invention relates to a locking device provided with at least one locking point for a sliding sash.

The locking devices in accordance with the invention are particularly adapted to locking windows, doors, sliding patio doors or the like constructed from an assembly of profiled parts, in particular aluminum profiled parts.

### STATE OF THE ART

In opening sashes of the horizontal translation type, the closure systems generally used consist solely of a rod fixed in a sliding manner on an element of the frame laterally bordering the sashes. In the locked position this rod traverses, in a bore, the profiled part of the frame and the profiled part of the sliding sash. These closure systems, however, prove to be inadequate in preventing every attempted break-in, owing to the fact that they provide only a single locking point for the sash.

Furthermore, sash bolt-type closure systems are also known, in particular from the document WO 2008/153707. These systems generally use an operating button fixed in a pivoting manner on the sliding sash. Upon rotation, this operating button actuates a toothed pinion which meshes with racks which are cut in, or fixed to, the end of linkages sliding within channels formed inside the sash. The rotational movement of the pinion thus causes a straight translational movement of the linkages, either upwards or downwards, so that their ends are positioned in an orifice in the strike plate integrated in the upright of the frame. These closure systems thus have the advantage of providing two locking points for the sash. However, these closure systems have been found to take up a relatively large amount of space inside the sash. These systems can thus not always be used inside sashes formed by metal profiled parts, generally made of aluminum or polyvinyl chloride. Indeed, in these profiled parts, the distance between the inner walls is often reduced to a minimum and thus does not allow the mechanical elements used in the sash bolt-type closure systems to be accommodated.

The present invention thus aims to provide a solution to the problem mentioned above.

### DISCLOSURE OF THE INVENTION

To this end, the present invention concerns a locking device provided with at least one locking point, in particular for windows, doors, sliding patio doors or the like constructed from an assembly of profiled parts, having at least one locking bar sliding inside a sash, the said bar being moveable under the action of a sliding unit fixedly attached to the said bar between an unlocking position, in which the said bar is disposed outside a frame element adjacent to the said sash, and a locking position, in which the said bar is disposed partially inside the said frame element, and at least one actuating element accessible from outside the said sash, wherein the said actuating element is configured to act on an associated member connected to the sliding unit when it is displaced in translation along an axis of displacement from an initial position to a final position so as to cause displacement of the said locking bar from its unlocking position to its locking position. Other possible configurations of the invention are defined in the dependent claims.

Being thus configured, the locking device in accordance with the invention takes up relatively little space, in particular in terms of depth, within the sliding sash. It can thus easily be adapted to any type of sliding sash. Furthermore, when the push button actuating the locking device on the outside is integrated into the frame bordering the sliding sash, this locking device provides an additional closure point. This thus limits the risks of break-in.

The invention also relates to a sliding sash element having at least partially a locking device as described above.

### BRIEF DESCRIPTION OF THE DRAWINGS

Other advantages and features of the present invention will be better understood from reading two particular embodiments of the invention and with reference to the drawings in which:

FIG. 1a illustrates a partially cross-sectional elevational view of a sliding sash element inside a frame, the said element at least partially including a first embodiment of the locking device in accordance with the invention;

FIG. 1b illustrates a partially cross-sectional plan view of the sliding sash element illustrated in FIG. 1a;

FIG. 1c illustrates a partially cross-sectional top view of the sliding sash element illustrated in FIG. 1a;

FIG. 2a illustrates a partially cross-sectional elevational view of a sliding sash element inside a frame, the said element at least partially including a second embodiment of the locking device in accordance with the invention;

FIG. 2b illustrates a partially cross-sectional plan view of the sliding sash element illustrated in FIG. 2a;

FIG. 2c illustrates a partially cross-sectional top view of the sliding sash element illustrated in FIG. 2a;

FIG. 3a illustrates a detailed view of the lower sliding unit illustrated in FIG. 1 a or 2a;

FIG. 3b illustrates a detailed view of the lower sliding unit illustrated in FIG. 1b or 2b;

FIG. 3c illustrates a detailed view of the lower sliding unit illustrated in FIG. 1c or 2c;

FIG. 4a illustrates a detailed view of the actuating element illustrated in FIG. 1a;

FIG. 4b illustrates a top view of the actuating element illustrated in FIG. 4a;

FIG. 4c illustrates a bottom view of the actuating element illustrated in FIG. 4a;

FIG. 5a illustrates a partially cross-sectional elevational view of the casing within which the actuating element of FIG. 4a slides;

FIG. 5b illustrates a plan view of the casing illustrated in FIG. 5a;

FIG. 5c illustrates a top view of the casing illustrated in FIG. 5a.

### DETAILED DESCRIPTION OF ONE EMBODIMENT OF THE INVENTION

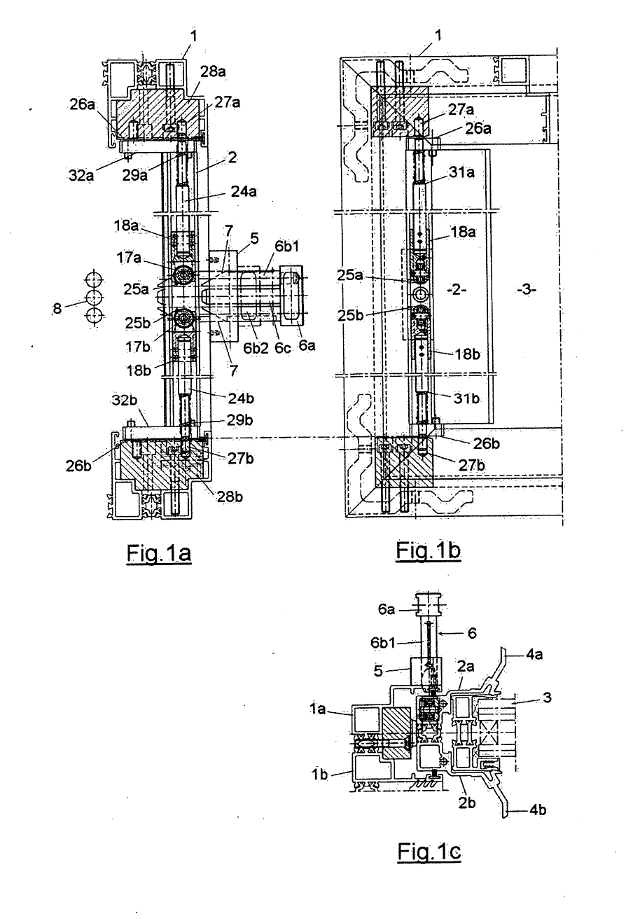

FIGS. 1a, 1b and 1c show fittings for a door/window aperture in which a locking device in accordance with the invention is used. These door/window aperture fittings include a door/window aperture frame 1, a sash 2 sliding on a horizontal axis, the said sash enclosing glazed elements 3 fixedly attached to the said sash. The door/window aperture frame 1 and the sliding sash 2 are formed from standard profiled parts of aluminum or another metal, cut to the desired length and assembled by riveting, crimping or some other means. The dimensions and profile shapes of the various standard profiled parts used will be adapted in each case to the desired function, ensuring their rigidity and rendering the door/window aperture frame non-deformable. The sash 2 is, in particular, formed from two profiled parts 2a and 2b disposed symmetrically with respect to a vertical middle plane, the said profiled parts 2a and 2b being disposed on both sides of the glazed elements 3. A wing 4a and 4b formed at the end of each of the profiled parts 2a and 2b and extending substantially perpendicularly to the vertical middle plane of the sash 2 acts as a handle so as to facilitate maneuvering of the sash 2. The sliding mounting of the sash 2 inside the frame 1 is not part of the object of the present invention and will consequently not be described.

FIG. 1c shows the shape of the vertical frame element against which the sash 2 will come into abutment in its closed position. This element is formed by assembling two profiled part segments 1a and 1b disposed on both sides of the sash 2 and connected by means of intermediate elements. One of the profiled parts 1a is an inner profiled part of the door/window aperture. This profiled part 1a has, in particular at one end which adjoins the profiled part 2a of the sash 2, a casing 5, inside which a push button 6 slides. As we will see in detail hereinunder, the push button 6 is configured to act upon a locking mechanism disposed inside the sash 2 so as to lock the sash 2 inside the frame 1. This push button 6 is formed, in particular, of a grasping head 6a disposed in an extension of three parallel cylindrical rods, respectively an upper rod 6b1, lower rod 6b2 and central rod 6c. These rods 6b1, 6b2 and 6c are intended to slide in succession inside through bores 7 formed in the casing 5 and inside through bores 8 formed in the profiled parts 1a and 2a of the frame 1 and of the sash 2 in alignment with the through bores 7. In order to facilitate understanding of the drawings, the bores 8 have been shown in a side view of the left side of FIG. 1a. In a configuration which is not shown it is also possible to envisage the use of a non-circular profile for the rods 6b1, 6b2 and 6c. In particular, the rods 6b1, 6b2 and 6c can have a substantially rectangular profile. In this case the through bores 7 and 8 will be replaced by cylindrical through holes, the rectangular base of which will be of a shape substantially complementary to that of the profile of the rods of the push button 6. Thus, when it is sliding inside the casing 5, the push button 6 passes, in particular, from a position, called the initial position, in which the rods 6b1, 6b2 and 6c are disposed outside the sash 2 as illustrated in solid lines in FIG. 1a, to a position, called the final position, in which the said rods 6b1, 6b2 and 6c are disposed at least partially inside the sash 2, as shown partially in broken lines in FIG. 1a. In this last position the rods 6b1, 6b2 and 6c are thus positioned straddling between the profiled part 1a of the frame 1 and the profiled part 2a of the sash 2, thus preventing horizontal displacement of the sash 2 inside the frame 1. However, in a configuration which is not shown, the casing 5 can be fixed to the sash 2 and not to the frame 1. In this case the rods 6a, 6b1 and 6b2 will not be positioned straddling between the frame 1 and the sash 2 in the final position of the push button 6. In this configuration the push button 6 will act solely on a locking mechanism inside the sash 2 so as to lock the sash 2 inside the frame 1.

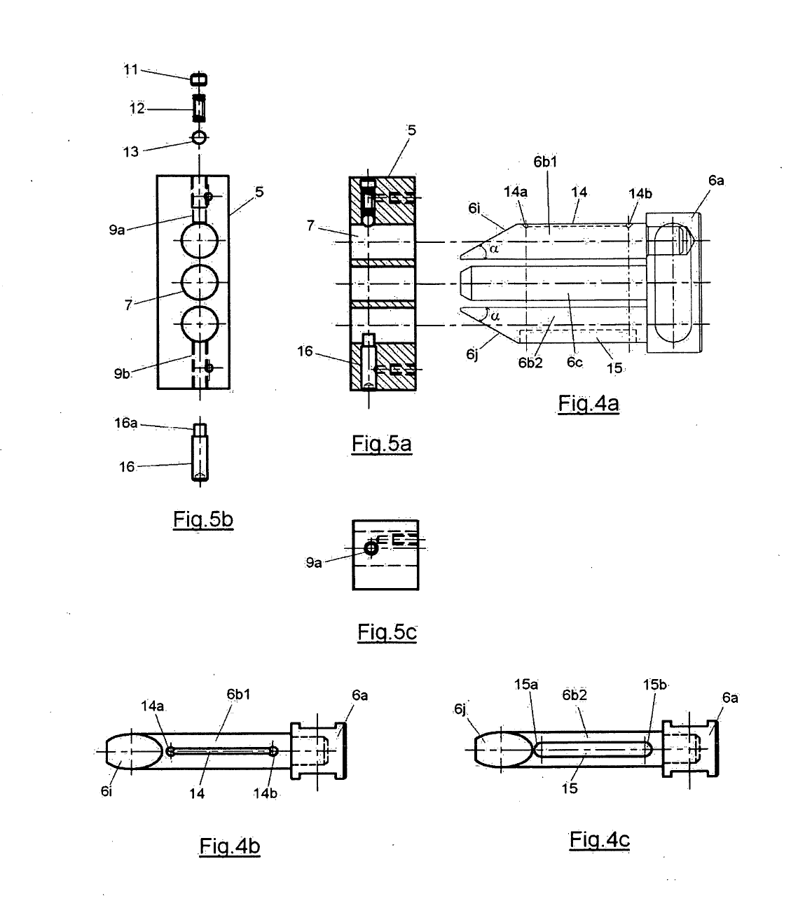

FIGS. 4a, 4b, 4c and 5a, 5b, 5c show a particular configuration of the push button 6 and of the casing 5. This configuration, in particular, makes it easy for the user to identify the initial and final positions of the push button 6. In this respect, as illustrated in FIGS. 5a to 5c, the casing 5 has a housing 9a issuing into the upper through bore 7, inside which the upper rod 6b1 of the push button 6 slides. The said housing 9a is, in particular, formed by a through bore, one end of which is open and issues into the upper bore 7, and the other end of which is closed by a headless screw 11. The housing 9a is intended to house a helical spring 12 in abutment against the bottom of the housing 9a and acting on a ball 13 so as to repel the ball 13 to the outside of the housing 9a. The said ball 13 is intended to come to be housed at least partially inside cavities 14a and 14b formed on the outer periphery of the rod 6b1 when the push button 6 is in its initial and final position respectively. In order to facilitate the displacement of the push button 6 from its initial position to its final position, the rod 6b1 has a guide groove 14 which is substantially semi-cylindrical and is formed along its outer periphery, the said groove 14 joining the cavities 14a and 14b. This groove 14 is, in particular, configured to guide the ball 13 during displacement of the push button 6 from its initial position to its final position and vice versa. The depth of the groove 14 will therefore be less than the depth of the cavities 14a and 14b. Furthermore, in order to limit the displacements of the push button 6 inside the casing 5, the rod 6b2 has a groove 15 formed on its outer periphery, the said groove 15 being configured to at least partially house the end 16a of a swivel screw 16, the threaded rod of which traverses the casing 5 at a tapped hole 9b issuing into the lower through bore 7, inside which the lower rod 6b2 of the push button 6 slides. In the mounted position of the push button 6 inside the casing 5, the end 16a of the screw 16 exceeds the inner periphery of the lower through bore 7 so as to become positioned at least partially inside the groove 15 of the push button 6. The interaction between this end 16a and the lateral edges 15a and 15b of the groove 15 thus defines two stop positions for the push button 6. Finally, in order to improve the positioning of the sash 2 with respect to the frame 1, in particular in its locking position, the central rod 6c is of a substantially conical shape at its end. Therefore, when the push button 6 moves progressively from its initial position to its final position, the rod 6c progressively passes to the inside of the through bores 8 formed in the profiled part 2a of the sash 2. During this maneuver, the conical shape of the end of the rod 6c effects progressive recentering of the bores 8 on the axis of the rod 6c and therefore guarantees correct positioning of the sash 2 in the frame 1. This correct positioning improves the operation of the locking mechanism housed inside the sash 2.

FIGS. 4a to 4c also show that each of the rods 6b1 and 6b2 has a beveled shape, 6i and 6j respectively, at its end. These beveled shapes 6i and 6j will preferably be symmetrical with respect to the horizontal plane containing the axis of the rod 6c and will form an angle a of between 15° and 30° with the said plane. As illustrated in FIG. 1a, when the sash 2 is correctly positioned inside the frame 1, as seen previously, each of these beveled shapes 6i, 6j is configured to come into contact with the outer cylindrical ring of an upper ball bearing 17a or lower ball bearing 17b mounted in a sliding manner inside the profiled part 2a or 2b of the sash 2. For this reason, when the push button 6 moves from its initial position to its final position, the beveled shape 6i of the rod 6b1 causes upwards vertical displacement of the upper ball bearing 17a, and the beveled shape 6j of the rod 6b2 causes downwards vertical displacement of the lower ball bearing 17b. Thus when the push button 6 is in its final position, the ball bearings 17a and 17b are respectively in contact with the non-beveled cylindrical part of the rods 6b1 and 6b2. In FIG. 1a this arrangement has been shown in broken lines. Of course, other cylindrical bearing means can be used instead of ball bearings 17a and 17b. Moreover, in one embodiment of the invention; not illustrated, the use of mechanical members mounted in a sliding manner inside the profiled parts 2a or 2b instead of cylindrical bearing means may also be envisaged, the said members having, in particular, an inclined face complementary to that of the rod 6b1 or 6b2 so that the said members move vertically when the push button 6 moves horizontally from its initial position to its final position and vice versa. Each of these members will, in particular, be fixedly attached in translation to a sliding unit on which a locking bar is fixed. The locking bar is configured to become positioned partially inside a cavity or a hole formed in an element of the frame adjacent to the profiled part 2a or 2b when the sliding unit moves vertically upwards or downwards under the action of the associated member. In this position it straddles between the frame 1 and the sash 2 and thus prevents horizontal sliding of the sash 2 with respect to the frame 1.

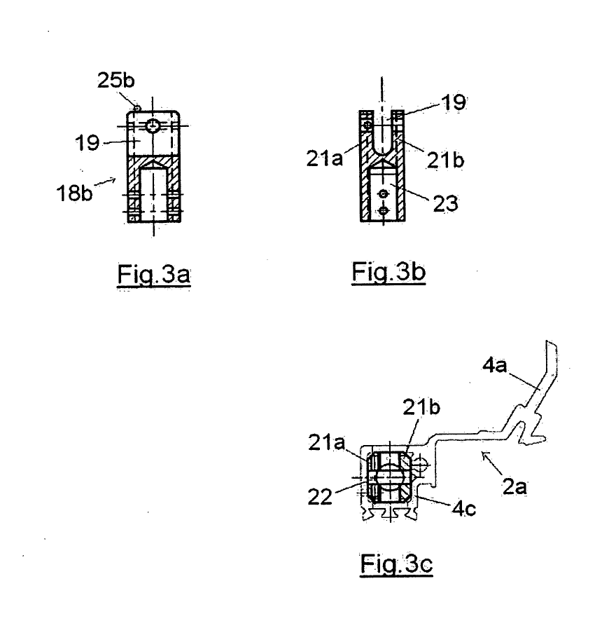

In the configuration illustrated in FIGS. 1a to 1c and as illustrated in detail in FIGS. 3a to 3c, the lower sliding unit 18b, fixedly attached in translation to the ball bearing 17b, substantially defines a rectangular parallelepiped, the outer edges of which have been chamfered. As illustrated in FIG. 3c, this rectangular parallelepiped occupies substantially all the space available within the tubular end 4c of the profiled part 2a so that the sliding unit 18b is able to slide without play inside the said tubular end 4c. In its upper part the sliding unit 18b is of a forked shape formed by two lateral wings 21a and 21b separated by a central recess 19 in which the ball bearing 17b comes to be housed. The ball bearing 17b is mounted so as to pivot about a spindle 22 fixed at its ends to the lateral wings 21a and 21b. In its lower part the sliding unit 18b is pierced by a blind hole 23 with a vertical axis. This blind hole 23 is intended to receive the upper end of a lower locking bar 24b, the said end being fixed to the lower part of the said sliding unit 18b, for example by means of pins. The upper sliding unit 18a differs from the lower sliding unit 18b only by its reversed arrangement inside the profiled part 2a. As shown in FIGS. 1a and 1b, and as shown in detail in FIG. 3a, abutment elements 25a and 25b, for example of a pin type, are disposed protruding along an inner wall of the tubular end 4c of the profiled part 2a so that one of the lateral wings of the lower part of the sliding unit 18a and of the upper part of the sliding unit 18b respectively comes into abutment against the said abutment element 25a and 25b respectively during the respective downwards vertical displacement and upwards vertical displacement thereof. In the illustrated configuration the respective positions of these abutment elements 25a and 25b have been chosen so that they correspond to an unlocking position for the device of the invention. In this unlocking position, the upper end and lower end respectively of the respective locking bar 24a, 24b is disposed so as to lie flush under the upper edge 26a and lower edge 26b respectively of the sash 2. In this position the sash 2 is thus free to slide in the frame 1. Furthermore, the positions of the abutment elements 25a and 25b have been chosen so as to align the bearings 17a and 17b with the rods 6b1 and 6b2. Thus when the push button 6 moves horizontally from its initial position to its final position it simultaneously causes the vertical displacement of the bearings 17a and 17b and, consequently, that of the assemblies formed by the sliding units 18a and 18b and the locking bars 24a and 24b. During this vertical displacement, the upper end and lower end respectively of the respective locking bar 24a and 24b comes to be progressively positioned outside the sash 2, in particular after having traversed an opening formed in the upper edge 26a and lower edge 26b respectively of the sash 2 so as to pass progressively into a respective blind hole 27a, 27b formed in an element 28a, 28b respectively of the frame 1 which adjoins the respective upper edge 26a and lower edge 26b of the sash 2. Thus, when the push button 6 is in its final position, the locking bars 24a and 24b pass relatively deeply into the holes 27a and 27b, consequently preventing horizontal sliding of the sash 2 inside the frame 1. This thus defines two additional locking positions. In order to return the locking bars 24a and 24b automatically to their unlocking position, a respective helical spring 29a, 29b is disposed along a smaller diameter upper part and lower part respectively of the respective locking bar 24a, 24b, the said spring 29a, 29b respectively being in abutment at its respective lower end and upper end against a respective shoulder 31a, 31b, formed on the outer periphery of the locking bar 24a, 24b respectively, and at its respective upper end and lower end against an inner wall 32a, 32b respectively of the sash 2. However, it should be noted that when the locking bars 24a and 24b are in their locking positions, the bearings 17a and 17b being in abutment against the non-beveled cylindrical parts of the rods 6b1 and 6b2, the return movement to the unlocking position cannot take place automatically. In fact it is necessary first to displace the push button 6 slightly so that the bearings 17a and 17b come into contact with the beveled faces 6i and 6j of the rods 6b1 and 6b2.

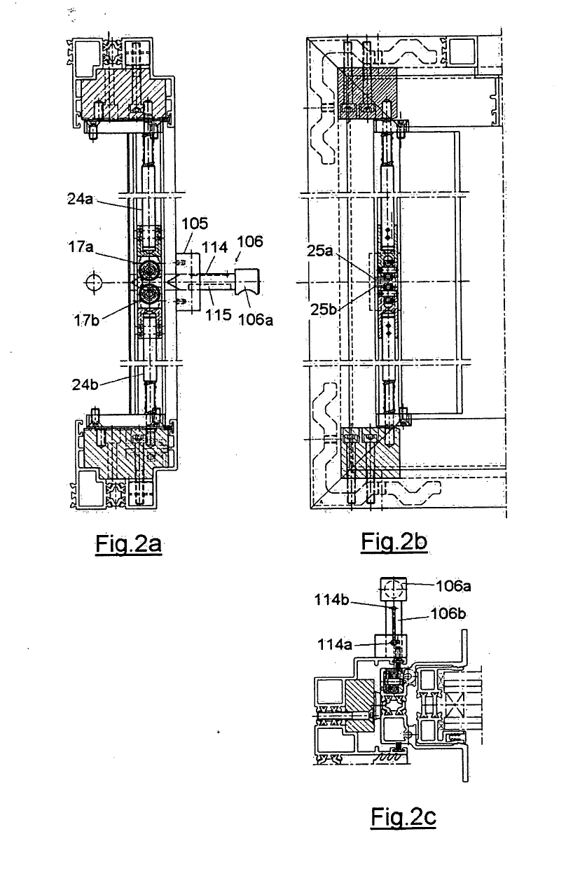

FIGS. 2a to 2c show a second embodiment variation of the invention. This embodiment differs from the embodiment described above in that it uses a push button with a single rod. Since, in this variation, the structure of the frame 1, of the sash 2, of the assemblies formed by the ball bearings 17a and 17b, by the sliding units 18a and 18b and by the locking bars 24a and 24b is substantially identical to that of FIGS. 1a to 1c, the following description will relate only to what differentiates this embodiment from the preceding one.

As shown in FIG. 2a, it should be noted that the push button 106 has a grasping head 106a disposed as an extension of a substantially cylindrical rod 106b, the free end of the said rod 106b having a first beveled shape on its upper semi-cylindrical edge and a second beveled shape on its lower semi-cylindrical edge, the said beveled shapes converging substantially at the horizontal middle plane containing the axis of the rod 106b. As in the preceding embodiment, each of the beveled shapes forms an angle between 15° and 30° with this middle plane. In the same way as the beveled shapes of the rods 6b1 and 6b2 of the preceding embodiment, the beveled shapes of the rod 106b are configured to act simultaneously on the bearings 17a and 17b when the push button 106 moves from its initial position to its final position in such a way as to cause vertical displacement upwards and downwards respectively of the said bearings 17a and 17b and, consequently, in such a way as to cause the locking bars 24a and 24b to move from their unlocking position to their locking position. In order to do this the abutment elements 25a and 25b, which define the lower and upper positions respectively of the bearings 17a and 17b, are disposed in such a way that the respective lower and upper semi-cylindrical edge of the bearings 17a and 17b is aligned with the upper and lower beveled shape respectively of the rod 106b. Furthermore, in the same way as the cavities 14a and 14b and the guide groove 14 of the rod 6b1, the rod 106b is also provided on its outer periphery with cavities 114a and 114b connected by a guide groove 114 so as to facilitate identification of the initial and final positions of the push button 106 and the displacement of the push button 106 between these two positions. In the same way, a groove 115 formed along the outer periphery of the rod 106b makes it possible, in cooperation with a stop element (not shown) fixedly attached to the casing 105, to limit the movements of the push button 106 inside the casing 105.

In one configuration of the invention which is not shown, it is also possible to envisage the use of a push button provided with a single rod, the said rod having a substantially rectangular profile and being provided at its free end and on its upper and lower faces with two bevels converging on a middle plane. Furthermore, in order to improve the positioning of the sliding sash during locking, the rod will be provided with a chamfer substantially at 30° on each side of the bevels.

In the embodiments illustrated in FIGS. 1a to 1c and 2a to 2c, the locking device of the invention defines three locking points inside the frame of the door/window aperture. Of course, it is possible to envisage designing an embodiment variation of the invention in which a higher or lower number of locking points would be defined. In particular in the embodiment illustrated in FIGS. 1a to 1c, it is possible to envisage the use of a push button in which the rod 6b1 and/or the rod 6b2 would not be present. In this case, the locking device of the invention would define only either two locking points or a single locking point. In the same way in the embodiment shown in FIGS. 2a to 2c it is possible to envisage the use of a push button in which the rod 106b would have only a single beveled shape. In this case the locking device of the invention would define only two locking points.

1. Locking device provided with at least one locking point, in particular for windows, doors, sliding patio doors or the like constructed from an assembly of profiled parts, having at least one locking bar sliding inside a sash, the said bar being moveable under the action of a sliding unit fixedly attached to the said bar between an unlocking position, in which the said bar is disposed outside a frame element adjacent to the said sash, and a locking position, in which the said bar is disposed partially inside the said frame element, and at least one actuating element accessible from outside the said sash, wherein the said actuating element is configured to act on an associated member connected to the sliding unit when it is displaced in translation along an axis of displacement from an initial position to a final position so as to cause displacement of the said locking bar from its unlocking position to its locking position.

2. Locking device according to claim 1, wherein the axis of displacement of the actuating element is substantially perpendicular to the axis of displacement of the locking bar.

3. Locking device according to claim 1, wherein the associated member consists of a cylindrical bearing means pivotably mounted at one of the ends of the sliding unit and wherein the actuating element is provided with at least one inclined face on its outer periphery, the said face being able to come into contact with the outer cylindrical periphery of the said bearing means during displacement of the said actuating element from its initial position to its final position so that the said bearing means moves in translation in a direction substantially perpendicular to the axis of displacement of the said actuating element.

4. Locking device according to claim 1, wherein it comprises two locking bars moving in the same direction perpendicular to the axis of displacement of the actuating element, the sliding units corresponding to each of the said bars being fixed at one of the ends of the said bars, and wherein the associated members of each of the said sliding units being positioned, when the bars are in their unlocking position, so that the actuating element is able to cause the simultaneous displacement of the said locking bars from their unlocking position to their locking position when it is displaced from its initial position to its final position.

5. Locking device according to claim 1, wherein the actuating element is in the form of a push button having at least one substantially cylindrical rod sliding inside a casing fixedly attached to the frame or to the sash, the free end of the said rod having a beveled shape on its lower and/or upper semi-cylindrical edge, and a grasping head disposed in an extension of the said rod.

6. Locking device according to claim 5, wherein the actuating element is in the form of a push button having at least one lower rod and at least one upper rod which are substantially cylindrical, the free end of the said lower rod and upper rod respectively having a beveled shape on its lower and upper semi-cylindrical edge respectively, and a grasping head disposed in an extension of the said rods.

7. Locking device according to claim 6, wherein the push button has a substantially cylindrical central rod disposed between the lower rod and the upper rod, the said central rod being configured to come to slide inside a through hole formed in the casing.

8. Locking device according to claim 5, wherein the beveled shapes of the rod or rods are defined by an oblique face forming an angle a between 15° and 30° with the axis of displacement of the push button.

9. Locking device according to claim 5, wherein the push button slides inside a casing fixed to the frame so that, when the push button is in the initial position, its rod or rods are disposed outside the sash and, when the push button is in the final position, its rod or rods are disposed partially inside the sash.

10. Locking device according to claim 9, wherein the said casing has at least one through hole inside which slides at least one rod of the push button and at least one housing issuing in the said hole, the said housing being intended to house a helical spring in abutment against the bottom of the said housing and acting on a ball so as to repel the said ball to the outside of the said housing, the said ball being configured to become housed at least partially inside a corresponding cavity formed on the outer periphery of the said rod when the push button is in its initial or final position.

11. Locking device according to claim 9, wherein a groove formed on the outer periphery of at least one rod of the push button is configured to house at least partially a stop element disposed protruding over the inner periphery of a through hole formed in the casing, inside which slides the said rod so that the displacement of the push button inside the casing is limited in at least one direction by one of the lateral edges of the groove.

12. Locking device according to claim 11, wherein the stop element is formed by a screw, the threaded rod of which traverses the casing at a tapped hole issuing into the said through hole, so that the end of the screw is positioned protruding with respect to the inner periphery of the said through hole.

13. Locking device according to claim 1, wherein a helical spring disposed along the locking bar is in abutment at one of its ends against a shoulder formed on the outer periphery of the locking bar and at its other end against an inner wall of the sash so that the said spring tends to return the said bar to its unlocking position.

14. Locking device according to claim 1, wherein an abutment element, disposed at least partially protruding over a transverse inner wall of the sash along which the sliding unit slides, limits the movement of the said sliding unit, the locking bar being in its unlocking position when the sliding unit comes into contact with the said abutment element.

15. A sliding sash element having at least one locking device according to claim 1.
